(19) United States
(12) Patent Application Publication
(10) Pub. No.: US 2011/0228115 A1
(43) Pub. Date: Sep. 22, 2011

(54) Large Format Digital Camera

(75) Inventor: Moshe Ben-Ezra, Beijing (CN)

(73) Assignee: Microsoft Corporation, Redmond, WA (US)

(21) Appl. No.: 12/724,883

(22) Filed: Mar. 16, 2010

(51) Int. Cl. H04N 5/228; H04N 5/225

(52) U.S. Cl. 348/208.7; 348/218.1; 348/E05.024; 348/E05.031

(57) ABSTRACT

A camera system is described for a large format digital camera for taking images of at least one gigapixel resolution. The camera system may include a lens, a sensor, a rigid housing that provides for minimal movement of the camera and a translation stage. The translation stage may include a vertical stage, a horizontal stage and a perpendicular stage such that the sensor is moved to incremental positions by the translation stage in a planned sequence. At each incremental position, the sensor comes to a complete stop to capture a tile image and then moves to the next position. Each tile image may overlap adjacent tile images such that the tile images are combined or mosaiced together to create a final complete image.

### BACKGROUND

Emerging applications in virtual museums, cultural heritage, and digital art preservation require very high quality and high resolution imaging of objects with fine structure, shape, and texture. Such applications require large format cameras for capturing high quality images, i.e., cameras with resolution in the order of one gigapixel. Existing technologies in both large format film cameras and large format digital cameras have been lacking in terms of cost, accessibility and complexity.

Large format film cameras have been used to take large format images which are later scanned to produce up to 4 gigapixel digital images. The processing time using this method is extremely slow. Other applications have included astronomical use in a telescope This type of application has resulted in a camera that uses an array of 4096 charge coupled devices (CCDs) to produce a 1.4 gigapixel image. A camera telescope has a relatively narrow field of view (FOV) and only focuses at infinity.

Large digital images have commonly been created in three ways. The first method involves scanning a regular film image taken by a large format camera. The second method involves taking multiple images by a moving camera and stitching the images together to create a mosaic. The third method uses a linear sensor to scan the image to create a large, usually panoramic image. In this method, a very strong light should be used. The sensor is moved in a continuous motion and images are sampled very fast and stitched together using the known mechanical speed. Most of these methods have not been able to produce an acceptable 1 gigapixel image. The exception is the mosaic method, which has produced images over 10 gigapixels, but at a relatively low resolution (separation) and is problematic due to the motion of the camera lens and image plane.

For all of these limitations in the existing art, the development of a high quality large format digital camera is needed for certain applications.

### SUMMARY

This document describes a large format digital camera system and methods of capturing an image. The camera system may include a lens, a sensor, a rigid housing that provides for minimal movement of the camera and a translation stage. The translation stage may include a vertical stage, a horizontal stage and a perpendicular (optical axis) stage such that the sensor (or lens) is moved to incremental positions by the translation stage in a planned sequence. At each incremental position, the sensor comes to a complete stop to capture a tile image and then moves to the next position. Each tile image may overlap adjacent tile images such that the tile images are combined or mosaiced together to create a final complete image.

Other aspects of the camera system may include a video camera that provides a field of view larger than that of the lens (and of a single tile) and is used to assist in the control of the camera system operation. In another aspect, the camera system may include a cooling system to cool the ambient air inside the housing. In yet another aspect, the camera may include a light source synchronized with the digital sensor to illuminate a tile image from different angles or different spectrum at each step to reduce the time to capture the tile images with different illumination. This is used, for example, for photometric stereo, multispectral imaging.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items.

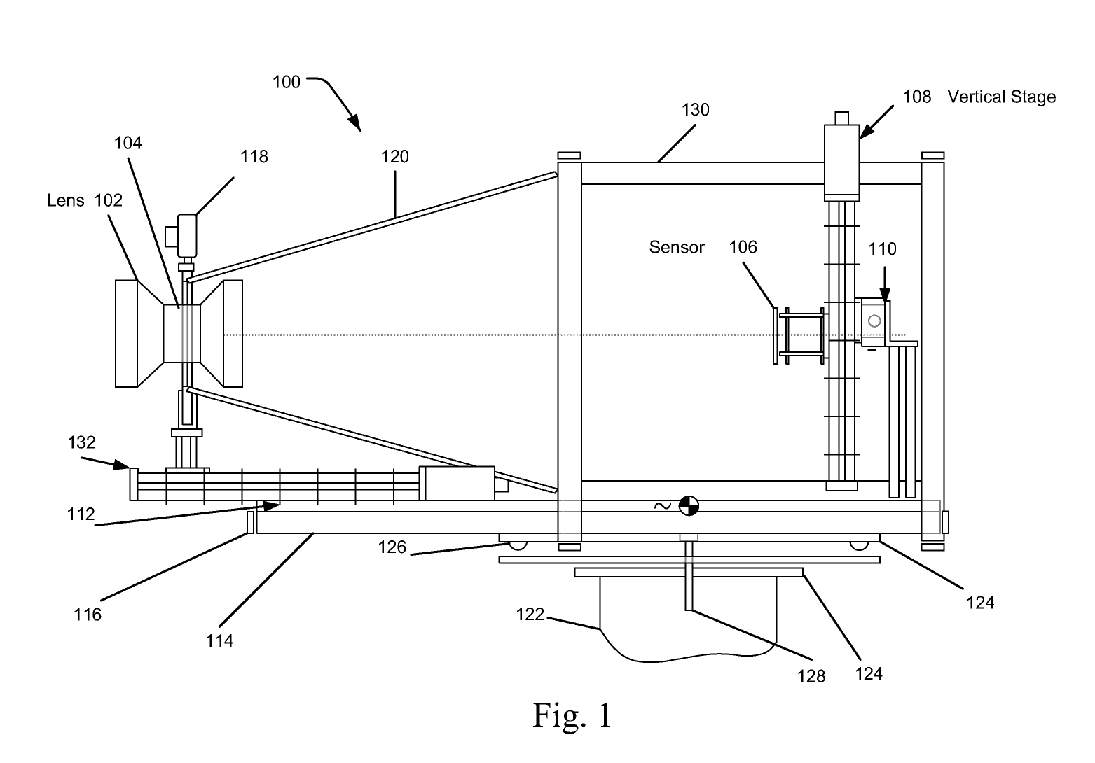

FIG. 1 depicts a side view of an illustrative embodiment of a camera system.

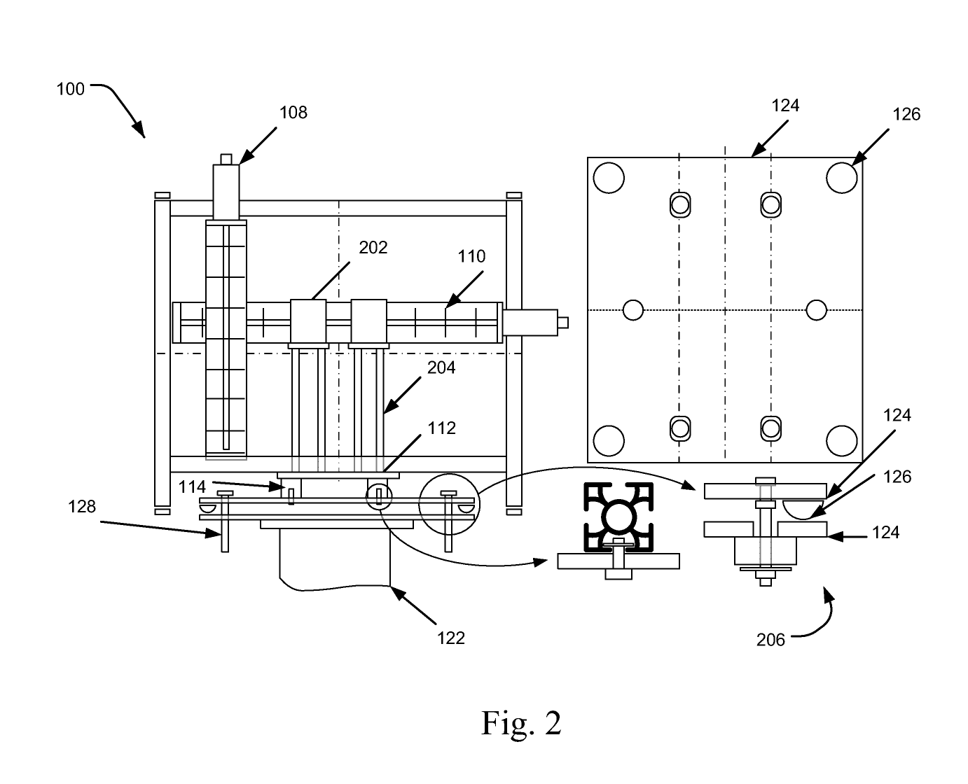

FIG. 2 depicts a back view of the camera system.

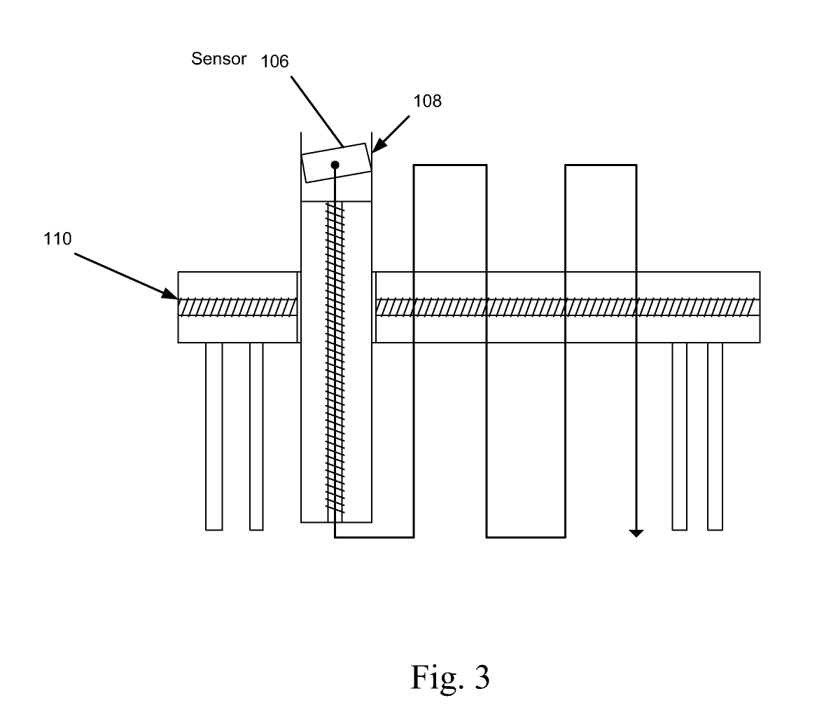

FIG. 3 illustrates an example motion of a translation stage of the camera system.

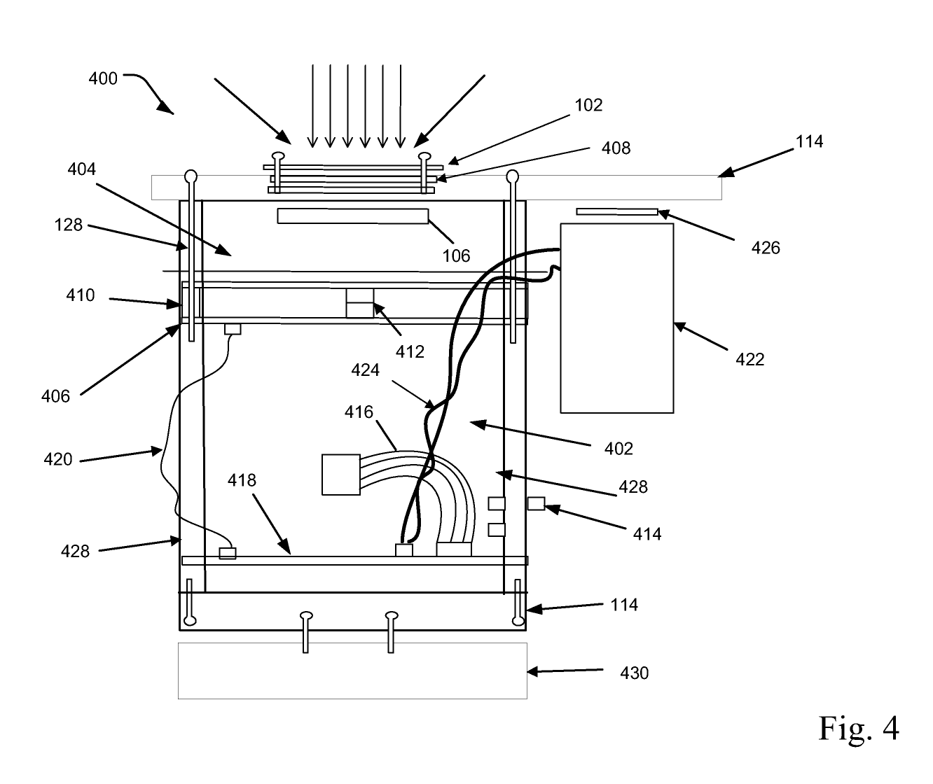

FIG. 4 depicts an embodiment of a sensor sub-system enclosure. [(moshe) this part is ˜10×6×10 cm. the camera enclosure is 90×60×50 cm . . . ]

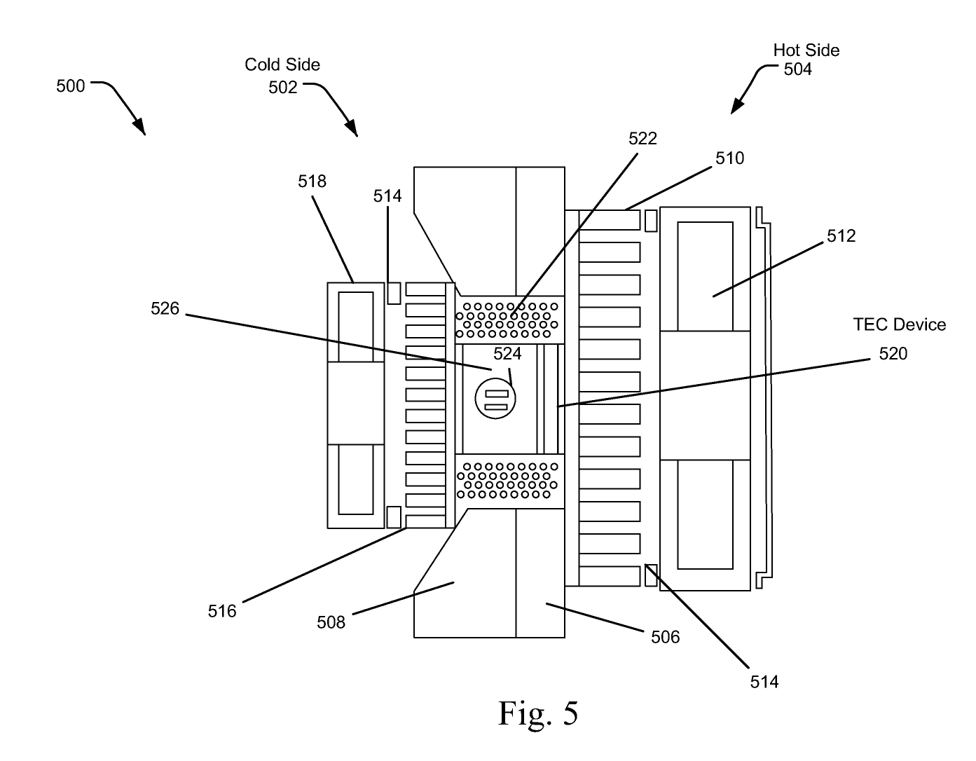

FIG. 5 depicts an embodiment of a camera cooling system.

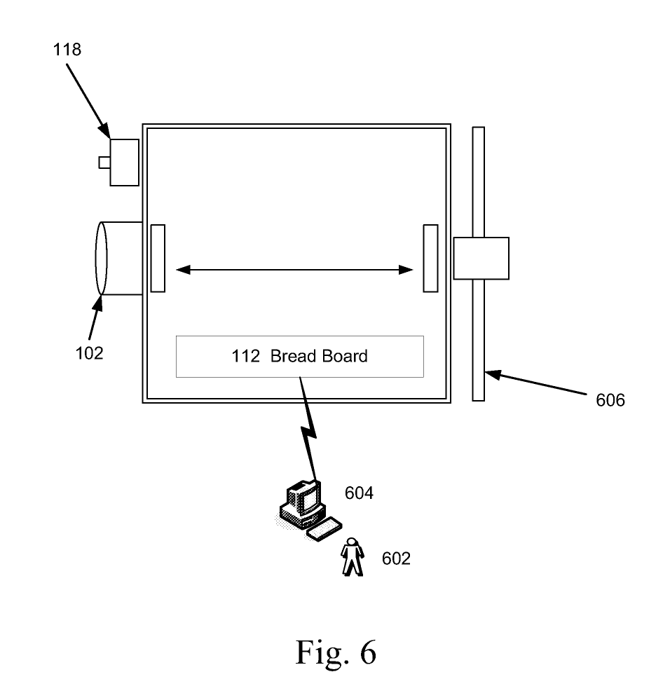

FIG. 6 depicts an embodiment of the camera system that may be controlled by a computer.

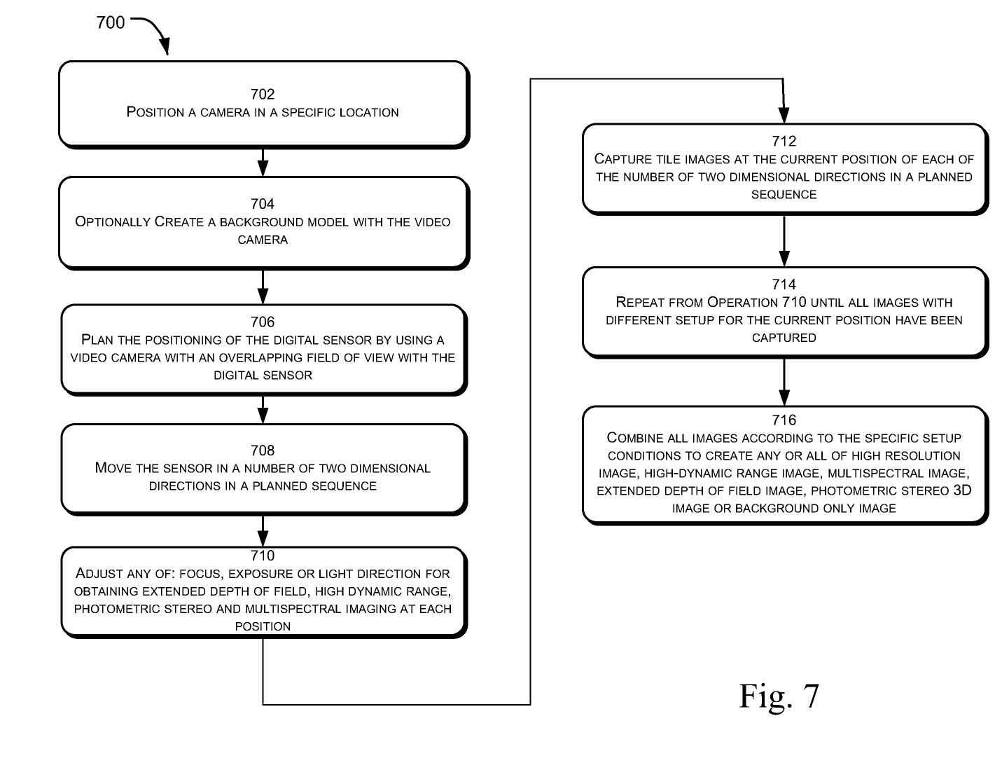

FIG. 7 is a flow diagram of an illustrative process for capturing an image.

### DETAILED DESCRIPTION

### Overview

As discussed above, large format digital cameras with a resolution of at least 1 gigapixel are very valuable for certain applications. However, there are many issues to overcome in building the camera and the present disclosure addresses these issues. This document describes a camera system for a large format digital camera that captures high resolution digital images in a timely and simple manner.

Illustrative Camera System

FIG. 1 depicts a side view of an illustrative embodiment of a camera system 100. Camera system 100 may include a lens 102, lens holder 104, a sensor 106 and translation stages 108, 110, 132. The lens holder 104 firmly and accurately attaches the lens to a focusing stage 132, while at the same time allows simple and easy replacement of the lens 102. The translation stage may include a vertical stage 106 and a horizontal stage 110. The camera system 100 may further include a breadboard 112, a platform or rails 114 and a cap 116. In one embodiment, the lens 102 does not move during image capture. Instead, the sensor 106 is moved by the vertical stage 106 in increments of a planned sequence and also move along the optical axis for focusing. In the illustrative embodiment, the lens 102 may move along the optical axis to change focus while the sensor moves horizontally and vertically only. A tile image is captured at each location of the planned sequence and the series of tile images are combined or mosaiced into a single 1 gigapixel image. As previously stated, the image plane stages (the horizontal stage 110 and the vertical stage 108) are responsible for moving the sensor 106.

The image plane stages are accurately aligned so the image plane is perpendicular to the optical axis. The image plane stages also allow fast and accurate motion of the sensor 106 and are able to hold the sensor 106 stable when at rest. The arrangement illustrated in FIGS. 1 and 2 minimizes the torque on the stages and the moving mass, as the vertical stage 108 moves only the square root of the number of sensor positions (to prevent motion blur and allow multiple image capture at the same location, the sensor 106 scans the image plane step by step and not continually). Rotating the sensor 106 slightly about the optical axis allows scanning through all color channels and eliminates the need for demosaicing. A third or perpendicular direction in the Z axis is optional and is not shown in the figures. The perpendicular stage can be used for fine focusing by moving the sensor. Rotation of the sensor can be omitted if the sensor slightly over-samples the optical image and a good demosaicing algorithm is used. The perpendicular stage may move in and out in relation to the horizontal and vertical stages or in the alternative, the lens 102 may be moved, or they both can be used for coarse and fine adjustment of focus. In another embodiment, the stages may be rotated to move in other than the horizontal, vertical or perpendicular directions. For instance, the plane may be scanned in a horizontal and vertical zigzag pattern as described herein but is not limited to horizontal and vertical zigzag scanning pattern.

The focusing stage 132 should move the lens holder 104 (and the lens 102) closer or further from the image plane. The focusing stage 132 provides firm support to the lens holder 104. The focusing stage 132 may be either a manual focus or a motorized focus. A manual focusing stage may be less costly and quite comfortable and intuitive to use. However, a manual focusing stage does not allow computer controlled auto focus. A motorized stage allows auto focus and better accuracy, and automated extended depth of field using focal stack.

A video camera 118 may be mounted near the lens 102 or on the frame 130, to provide additional functionality to the camera system. A bellows 120 may form a portion of the enclosure of the lens 102 and the sensor 106. A telescopic mount 122 may be attached to a pair of plates 124 and rubber bumpers 126. A safety screw 128 may be used to couple the plates 124, rubber bumpers 126 and telescopic mount 122. Finally, a housing 130 may be used to provide a rigid structure to enclose the camera system 100. In other embodiments, accuracy is provided by the skeleton, i.e., the breadboard and the vertical, horizontal and perpendicular stages.

The optional video camera 118 provides a continuous view of the scene. It is the view finder of the camera and is also used for other camera functions, such as capturing images of a crowded area to enable composition of an image of the background only without the crowd or the opposite, by planning the capture to the place and time where each tile is free of occlusions.

FIG. 2 depicts a back view of an embodiment of the camera system 100. The back view of the camera system 100 further illustrates the vertical stage 108 and the horizontal stage 110. The angle brackets 202 and the columns 204 are used to attach the horizontal stage 110 to the breadboard 112. The plates 124 are typically made of aluminum, although other materials may be used that provide the proper rigidity. FIG. 2 further illustrates the base support structure 206 which includes bumpers 126, plates 124, safety screws 128 and telescopic support 122. The rails 114 are located adjacent to the breadboard 112. Plates 124 are placed on additional plates 124 with bumpers 126 separating the plates 124 to provide additional isolation. Isolation is important to help ensure that the camera is not susceptible to any outside disturbances, such as vibrations. The base support structure 206 is coupled together using safety screws 128. The entire base support structure 206 is coupled to rails 114 that are attached to breadboard 112.

The camera system 100 may also be optionally equipped with illumination (not shown) that is synchronized with the sensor 106 and may illuminate the scene from the same or different angles using regular or different (such as spectral or polarized) illumination. This provides for obtaining multiple illuminations in conjunction with the sensor motion, thus significantly reducing the time required to capture these images since one mechanical pass is all that is needed. While flash illumination may be used, other embodiments may also be implemented. For instance, two types of illumination may be used: (1) ring illumination and (2) computer controlled directional illumination. Ring illumination is used to obtain evenly illuminated information. Computer controlled directional illumination is used for computer vision tasks such as photometric stereo.

Ring illumination may include lights arranged around the lens 102 to reduce shadows. In one embodiment, halogen lights are used. The halogen lights may be used in conjunction with an integral ultraviolet (UV) filter and color temperature correcting filter, such as OSRAM™ Cool Blue or regular halogen with Roscolux™ illumination correction filter. Due to the favorable spectral distribution of these lights, a faithful and rich full color range can be obtained (after color calibration). At full brightness, these lights are bright enough to let the camera work at a full frame rate fully compensating for the low fill factor of the sensor. These lights may also be dimmed to any desired level. The cooled sensor and dark current calibration images allow for capturing images with long exposure times and without significant noise.

For some applications, photometric stereo may be desirable to reduce specular reflection (highlights) as much as possible. This is accomplished by polarizing the illumination as well as the incoming light. For the light polarization, a linear polarizing filter, may be used specifically designed for illumination purposes (better temperature tolerance, lower cost, higher transmission (though less strict) than photographic filters). On the camera side, a photographic circular polarizer may be used. Some functions, such as photometric stereo, require illumination that may be controlled by the capturing computer during image capture. One embodiment may include four directional lights. These lights may be attached to the camera frame and may be controlled by a USB relay. By using these lights, photometric stereo may be applied to obtain fine 3D details. However, different numbers of lights may alternatively be used in other embodiments.

Compact fluorescent lamps (CFL) or LED may be used since they can be turned on/off rather quickly (no cooling time is needed) and because they do not produce a lot of heat. Another embodiment may use incandescent (preferably daylight) bulbs for actual photography. Note that spectral distribution is not very important for some functions, such as photometric stereo that uses grey scale images.

As discussed above, there are many considerations involved in selecting the components and capturing the images in a large format camera. Consequently, it is important to describe in detail the component selection process as well as the process for capturing a 1 gigapixel image.

There are several considerations when selecting the lens 102. Information that is lost by the lens cannot be later recovered. It is therefore important not only to select an optimal lens, but also to make sure not to degrade the image by adding unnecessary or low quality elements in the optical path.

Even for theoretical perfect conditions (diffraction limited monochromatic), the contrast of the image drops gradually as the details become finer, until the image is no longer resolved. This is expressed by a function called the modulation transfer function (MTF), which is a function of the aperture and of the spatial frequency (level of details). The contrast between black and white drops until there is no contrast at all. To be able to resolve the differences between a black and white line, the MTF value should be approximately 9% or better (Rayleigh criterion).

The situation becomes more complicated where real lenses are considered. The MTF of a real lens changes with location relative to the center of the image, lens aperture (due to diffraction and aberrations), distance from the object and the orientation of the pattern. This is too much information to display in a single graph, so lens manufacturers usually provide several graphs that provide part of the information. For example, the MTF of a Zeiss® standard lens at f-numbers 1.4 and 5.6 as a function of distance from the center of the image.

The MTF alone is not sufficient to select the lens, the size of the optical image also needs to be considered. One embodiment uses the Schneider Optics'™ APO SYMMAR 8.4/480. The Schneider lens has an FOV of 56. Further, the Schneider is designed for use with large format film. The Schneider lens can resolve 20 lp/mm at 40% MTF. However, if the number of pixels at the image circle that are obtainable at 40% MTF as πr²*4(lp/mm)² (pixels at Nyquist frequency) are computed, the Schneider™ lens can obtain 314 megapixels. In this equation, r is the radius of the image circle and lp/mm is line pairs per millimeter. If 10% MTF is three times the density of 40% MTF, a value of 2.8 gigapixels is obtainable for the Schneider lens. Further, due to a lower spatial resolution, the Schneider™ lens can work in a smaller aperture which means a better depth of field can be obtained. While lens distortion and light transmittance (vignetting) should also be considered, these aspects are usually very acceptable for large format lenses. Other lenses may also be used in other embodiments, such as the Rodenstock™ HR Digaron-S 5.6/60 lens.

As discussed above, the size of the image is also important. The effective image size produced by a given lens equals the resolution of the lens multiplied by the area of the projected image. The maximal pixel size and the minimal aperture should also be considered. Large apertures have stronger optical aberrations and a narrower depth of field (DOF) for the same optical magnification.

The following table shows the minimum resolution in line pairs per millimeter (lp/mm) required for obtaining a one gigapixel image, as well as the maximal pixel size in microns and smallest (diffraction limited) aperture for the required resolution.

| Format | Size | Res. | Pix. Size | f# |
|---|---|---|---|---|
| 35 mm | 36 × 24 mm | 538 | 0.9 | 2.8 |
| medium | 84 × 56 mm | 231 | 2.2 | 6.4 |
| large | 610 × 508 mm | 28 | 17.6 | 54 |
| very large | 450 × 300 mm | 43 | 11.6 | 35 |

While any of these formats are feasible to produce higher format resolutions, many parameters are considered for a particular application. For instance, the FOV of the lens, its distortion, vignetting, and uniformity across the FOV should all be considered. As discussed above, the Schneider's Apo-Symmar 8.4/480 is one of several lenses that satisfy these considerations. This lens has an image circle of 500 mm and a standard FOV of 56 degrees, it has good resolution and uniformity (across about 90% of its area) and exhibits very low distortion.

It is also important to select a suitable sensor 106. Most digital sensors are not suitable to work with large format lenses. A lens designed to work with a conventional digital sensor is telecentric at the sensor side and all colors are focused at the same plane. In contrast, a large format lens has an image circle that is much larger than the lens and therefore the projection cannot be telecentric. Additionally, the lens has slightly different focal planes for each of the three primaries to match the film's layered structure

One embodiment uses a sensor without microlenses since it exhibits only a slight degradation at the edge of the FOV compared to the center of the FOV (near the optical axis comparing to a sensor with microlenses. Additional embodiments may also use a sensor with microlenses that specifically design to have large field of view.

In one implementation, full frame or frame transfer charge coupled devices (CCDs) may be used. In the first case, a physical shutter may be used to prevent smearing during readout. Examples of physical shutters that may be used include, without limitation, a ferroelectric shutter or a mechanical shutter. In yet another implementation, a focal plane array of many CCDs may also be used in addition to or instead of the foregoing shutters.

In another implementation, frame transfer CCDs may be used when the sensor is small or when the exposure time is relatively long (as in telescopes).

In another implementation, an interline CCD with no microlenses may be used. Interline CCDs without microlenses reduce the amount of light less than a ferroelectric shutter without its additional complexity. A specific implementation may use the 11 megapixel Kodak® KAI-11002 sensor. Even without microlenses, the sensitive area is equivalent to a full frame sensor with pixel size of 6.3×6.3 μm, which is still large enough.

Other implementations may use linear and Time Delayed Integration (TDI) sensors. Linear sensors have one (or 3 for RGB) line of pixels and are used in conjunction with a moving image. TDI sensors are a special type of CCD linear sensor that may be clocked in such a way that the electronic image (the charge) is shifted at the same speed and opposite direction to the image motion across the CCD. This results in a continuous image strip that is exposed for exactly the time duration the image sweeps across the sensor, and with no motion blur. TDI sensors not only eliminate the motion blur, but are significantly faster than linear arrays for a given exposure time (by a factor of the width of the TDI sensor).

It is important that the frame be as rigid and accurate as possible to reduce image distortion and improve focusing operations. To get an accurate mechanical frame, which is helpful for a focused and non distorted image, optical table components may be used as building blocks. One embodiment uses a 190×20 cm double density optical board from Thorlabs™ of Newton, N.J. for the “spine” of the camera, to which may be attached two long travel (300 and 450 mm) motorized translation stages (vertical stage 108 and horizontal stage 110) (for sensor motion) from Zaber Technologies™ of Vancouver, B.C., Canada. A third translation stage (either manual or motorized) may be added for camera focusing. Rails may be used to support the optical board or breadboard 112 and to build the enclosure frame or housing 130. The rails may be made from aluminum or any other similar suitable material.

The lens holder 104 may be made of optical table posts and custom made aluminum bars. One embodiment uses a custom made Neoprene coated Nylon bellows from Gortite™ to connect the lens 102 to the housing 130. The lens holder 104 may also contain a mounting point for a video camera 118 that is firmly attached to the main lens and moves with the lens 102.

When a conventional camera is set to a different focal distance, the magnification of the camera (and the effective focal length) also changes (with the exception of cameras that are telecentric at the image side). In most cases, where the object is relatively distant with respect to the focal length and the image is relatively small, the change in magnification results in sub-pixel motion and can be ignored. Having a digital lens with (nearly) telecentric projection also helps in this respect. However, a large format camera operating in a relatively close range to the object exhibits very significant magnification changes that cannot be ignored. A large format camera cannot easily be made telecentric due to the difference between the image size and lens size. The change in magnification becomes a significant problem when trying to focus at a point (as the point drifts, sometimes even outside the field of view of the sensor) and when trying to extend the DOF using a focal stack. The magnification factor change due to focus shifts can be computed as shown below.

The image or transverse magnification of an object using the thin lens model is defined as M_{T}=yᵢ/yₒ, where yᵢ and yₒ, are image size and object size respectively. From triangular similarity M_{T}=−sᵢ/sₒ (negative M_{T} indicates inverted image). From the thin lens equation

1/f=1/sₒ+1/sᵢ (1)

the following equation is obtained:

sₒ=fsᵢ/(sᵢ−f) (2)

M_{T}=−sᵢ−f/f=−xᵢ/f (3)

where Sᵢ is total measurement on the image side, sₒ is the total measurement on the object side and xᵢ is a partial measurement on the image side and xₒ is a partial measurement on the object side such that f+xᵢ=sᵢ and f+xₒ=sₒ. Equation 2 is most commonly used for depth from focus. Equation 3, known as the Newtonian expression for magnification, provides the magnification factor as a function of internal parameters only (for in-focus objects).

The ratio ψ(δ) of the magnification factor as a function of moving the lens by δ is given by:

ψ(δ)=M_{T}(xᵢ+δ)/M_{T}(xᵢ)=(xᵢ+δ)/f*f/xᵢ=(xᵢ+δ)/xᵢ (4)

For example, pixels at the edge of a 2 k×2 k image focused one meter away and taken by a 50 mm lens are displaced by half a pixel when the lens is focused 10 mm further (in the object side). In contrast, pixels at the edge of a 20 k×20 k image taken with a 500 mm under the same conditions are displaced by 200 pixels.

Since the motion vector of point (i, j) for an image centered at the focus of expansion (FOE) is simply given by:

(i,j)→ψ(δ)(i,j) (5)

the horizontal and vertical translation stages may be moved in synchronization with the focusing stage. This keeps the image tile centered through the focusing process, which is useful also for focal stack processing. Note however, that this does not correct the magnification change within a tile.

Calibration of the focusing stage 132 and the image plane stages or horizontal stage 110 and the vertical stage 108 are important to the operation of the camera system 100. During calibration, the FOE due to magnification change is found in addition to the value of xᵢ. There is however a problem caused by the fact that the image is defocused when the lens is moved making it more difficult to estimate the exact motion.

To solve this problem, the defocus of a symmetrical feature (such as a point) may be used since it is symmetrical on both sides of the image plane whereas the magnification is not. Therefore, a pair of similarly defocused images of a set of points at both sides of the focal plane are captured. The images are registered to find the magnification change and FOE with the change of focus.

The translation vector is the correction to the true FOE and the scale is ψ(δ) from Equation 4. Since δ is accurately known (the focusing stage maximal error is no more that 45 μm) and xᵢ can be computed from Equation 4.

The image plane stages have an absolute error of no more than 23 μm (2.5 pixels) and repeatability error of no more than 3 μm (⅓ pixel). However, these numbers refer to the one dimensional motion of each stage. When the stages are placed in XY configuration, they are subject to additional errors mainly due to imprecise alignment of the two stages as well as imprecise alignment of the sensor. Additionally there could be a small error in the lateral direction that affects the other stage. The resulting error is a constant bias (caused by the angular errors) plus some perturbations. To calibrate for these errors, many images are taken of a textured test target and then the images are registered using a translation only motion model that measures the bias as well as the average residual error and variance at each position. In most cases the average error is sub pixels (or zero when the error was too small to detect), but in some locations the residual error is a few pixels long and is corrected during stitching

After calibration, the image may be captured. When capturing the image there are several guiding principles: (i) scan as fast as possible, (ii) avoid motion blur, and (iii) for certain multi-exposure images such as HDR images and photometric stereo, keep the images aligned (for a static scene).

To achieve these goals, the image is scanned in a step-scan manner as shown in FIG. 3. In a step-scan method, the sensor 106 stops completely before each image is taken. Stopping the sensor 106 completely allows long exposure times (in low light conditions) as well as very good alignment in multi-exposure conditions (the scan is done only once, where potentially several images are taken at each location). The image is scanned column by column zig-zag order as seen in FIG. 3, this path minimizes the moving mass as only n−1 movements of n²−n for n×n grid are horizontal motions that move the vertical stage 108, whereas the rest only move the sensor that has significantly lower mass. The captured tiles overlap each other. The overlapping regions are used later for better alignment and for tiled focal stack.

Thanks to low moving mass, acceleration controlled motion of the stages that minimize the vibration of the camera and accomplish parallel capturing and processing (using dual core CPU), a 40 k×30 k image is captured in less than 5 minutes (for 1/10 sec exposure time). This is significantly faster than other techniques including mosaics and a one dimensional (1D) scan by a linear sensor.

During and/or after an image is captured, all tiles are combined or mosaiced using the calibration data obtained previously to provide a quick high resolution preview of the captured image (in less than 5 minutes). A more accurate mosaic is then made by registering adjacent tiles using the overlapped regions between tiles. Since the displacement between frames is known up to a few pixels error (in most cases a sub-pixel error), a direct method for registration provides very fast and accurate results.

Focal stack is another consideration. Scaling up a camera greatly improves the image quality and the range of non-diffraction limited apertures. However, somewhat surprisingly, it does not significantly improve the DOF. The reason is that for the same object distance the optical magnification of the large camera is significantly higher, i.e., similar to macro lenses. Therefore, in order to keep the same high level of details for 3D objects that have depth variations larger than the DOF, the DOF of the camera may be extended. Several computational methods for extending the DOF using coded exposure or aperture have been proposed in recent years. The traditional focal stack method is used on one embodiment. The traditional focal method is simple, performs well and is time efficient.

In another embodiment, a simple tile-based focal stack algorithm may be used. This algorithm processes only one stack-tile (that, single location, multiple focus) at each step, which minimizes its memory footprint. It uses the minimal scale change at each step and addresses inconsistencies at the edges due to scaling. It then processes each tile (except the edges of the focal stack) in both directions to maximize the robustness of the algorithm. The principle of operation is to first create local focal stacks, merge them, and then move up one level and merge these using new local centers until all tiles are merged. One example of a focal stack algorithm is as follows:
Input: A set of n images taken at different focal distances where the DOFs of adjacent images are overlapping.
Output: Extended DOF image
1. Using the known scale and FOE, divide each image into overlapping tiles.
2. For each tile location (x, y) arrange the n focal stack tiles into triplets: (1, 2, 3), (2, 3, 4) . . . (n−2, n−1, 2)
3. For each triplet register (and warp) the two edge tiles to the center one, which is the ‘local focal stack center’.
4. For each triplet (i,j,k) merge the pairs (i,j), (j,k), using a Laplacian pyramid
5. For each triplet (i,j,k) merge the newly created pairs (i,j), (j,k) into a single tile. Resulting with total of n−2 tiles.
6. If (n>1) then set n←(n−2) and repeat from step number 2 (using different local focal stack center(s)).
7. For each location (x, y) remove the overlapping edges (that are corrupted by the warp operator), and stitch the clean central region to obtain an extended DOF image located at the global center of the focal stack.

FIG. 4 depicts an illustrative embodiment of a sensor sub-system enclosure. The sensor sub-system enclosure 400 is an example of how the sensor part of camera system 100 may be implemented. The sensor sub-system enclosure 400 includes two main portions, the electronic portion 402 and the sensor portion 404. The sensor portion 404 may be a solid aluminum component or some other rigid material that also includes the optical window frame 102 attached on one side and the sensor 106 and sensor electronics 406 attached to the other side. The sensor 106 may be sealed by a rubber ring on one side and an optical window 408 at the front. The optical window 408 may be attached using a thin frame 102 or by other attachment means. The two electronic cards 406 may be connected by a thin bar connecter 412 and spacers 410 placed at the corners where screws may secure the whole setup to the aluminum block. The electronic part 402 may be a thin aluminum box containing the USB connector 414, power connector (not shown) and Digital I/O connector 416, all connected to a single board 418. The board 418 may be connected to the sensor electronic board 406 by a flat cable 420. A fan 422 may also be attached to the single board 424. The fan 422 acquires power from the electric board 418 by a short wire 424. A felt layer 426 may be added to damp any vibrations from the fan 422. The electronics portion 402 and the sensor portion 404 are supported by posts 428 attached to plates 114. The posts 428 may be made from any suitable structural material such as steel. The frame created by attaching the posts 428 and the plates 114 are then attached to the vertical stage 130.

FIG. 5 depicts an embodiment of a cooling system for the camera. Unlike a large film format camera that can work at a relatively high temperature range (depending on the film used) from a few degrees above freezing to 40-50 degrees Celsius, a digital camera works best at low temperature that reduces the noise generated by the sensor 106 and electronics. Unfortunately, the sensor 106 itself is a strong source of heat. The sensor 106 alone may produce 18 W of heat. The translation stages also produce some heat. During use, the sensor 106 is moving and it should be in a light-tight enclosure, thus it is difficult to cool only the sensor 106

In one implementation, heat conductive material such as aluminum may be used to efficiently conduct heat while blocking light dust and humidity. A thin aluminum enclosure is light and can easily conduct the heat generated by the sensor 106 and translation stages 108 and 110. A thin, heat conductive material enclosure is the simplest solution that does not require any moving parts or energy to operate.

In another implementation, active cooling may be used. Active cooling uses a cooling element as well as fans. A large format camera is not air sealed and water condensation on the sensor is an issue. To prevent water condensation from occurring, the entire enclosure should be cooled. This keeps the sensor itself at a temperature that is above the (cooled) air that surrounds it and therefore, prevent condensation. Active cooling has the advantage of reducing the temperature below the ambient temperature and regulating the temperature. Both are important for obtaining high quality low noise images. Active cooling may be done in two major ways. The first uses an external unit (air conditioner) that circulates the cool air through the camera. The second solution uses thermoelectric cooling. Thermoelectric cooling uses the Peltier effect in semiconductors as a heat pump.

Returning now to FIG. 5, a thermoelectric cooling system 500 is shown. The thermoelectric cooling system 500 transfers heat from the cold side (camera) 502 to the hot side (room) 504. Air is forced into the cold heat sink 516 by the cold side fan 518. The heat is conducted by the spacer 526 to the cold side of the TEC device 520. The TEC device 520 actively transfers the heat to the hot heat sink 510, where it is dissipated by air from the hot side fan 512. Both fans 512 and 518 are mounted on the heat sinks 510 and 516, respectively, using rubber washers 514 to reduce vibrations. The assembly 500 is mounted to the back wall of the camera that includes of a wooden plate 506 for rigidity and thermal isolating Styrofoam 508. Granulated aerogel 522 is used to insulate the critical area TEC 520 and spacer 526. A safety switch 524 turns the power off at 85 degrees to protect the TEC device 520.

Keeping a regulated temperature not only reduces the thermal noise but allows better photometric calibration (using dark current images). The ability to use photometric calibration allows the camera to operate in relatively low light conditions that require long exposures. This may be important in museums where strong light may not be allowed. It becomes even more important if cross polarization is used since it further reduces the amount of available light. Thermoelectric devices (TECs) can achieve impressive temperature differences (ΔT=66-70 degrees for a single stage device). At equilibrium state, the thermal load should equal the heat transfer capability of all TECs used. A rough estimate can be obtained by the following equation:

nP_{T}e_{T}=Qa+kAΔT/L

The left hand side is the heat transfer capability consisting of: n, the number of TEC units used; P_{T}, the power of the TEC unit in watts; e_{T}, the efficiency of the TEC unit, typically (0.05 . . . 0.1). The right hand side is a simple thermal load estimate consisting of: Qa, active heat in Watts dissipating from the electronic/electro-mechanic components inside the enclosure. The ambient heat that enters the enclosure through the insulation layer should be added to Qa. The constant k is the thermal conductivity of the insulation (0.033 for Styrofoam), A is the surface area, ΔT is the temperature difference and L is the thickness of the insulation layer. Convection and radiation were excluded from this simple description.

When cooling a camera, water condensation is a significant concern. Water condensation on the sensor or lens can significantly distort the capture image. Additionally, water condensation or dripping on the sensor can damage it. Thus, in the illustrated example, the cooling assembly is located at the back of the camera. The lens is located as far as possible from the cooling assembly and thus kept relatively warm. The sensor is kept above the ambient temperature by its own generated heat. Any water condensation on the cold heat sink can drip to the bottom of the camera where it is absorbed by a cloth or other absorbent material placed there for this purpose. In extreme cases, the cooling unit may be placed outside the enclosure. Alternatively, a water duct or superabsorbent polymers (such as those used in baby diapers) can handle a significant amount of water condensation.

FIG. 6 depicts an embodiment in which the camera system may be controlled by a computer 604 which may be operated by user 602. The computer 604 may operate the various components of the camera such as the lens 102, the translation stage 606 and the video camera 118 and the main sensor 106.

### Illustrative Image Capture Process

FIG. 7 depicts a flow diagram of an illustrative process 700 for capturing an image. Operation 702 positions a camera in a specific location for capturing a certain image. An optional background model using an auxiliary camera is created in operation 704. In one implementation, the auxiliary camera may be a video camera. The positioning of the digital sensor is planned in operation 706 using a video camera with an overlapping field of view with the main lens. [(moshe) the sensor itself has very limited field of view] The sensor is moved in a number of two dimensional directions in a planned sequence in operation 708. In one implementation, the planned sequence is a zigzag pattern. However, different planned sequences may be used depending on the circumstances of a particular scene. In operation 710, the various adjustable parameters may be adjusted. These parameters may include focus, exposure and light spectra and direction. The adjustments are made to obtain extended depth of field, high dynamic range, photometric stereo and multispectral imaging at each position of the planned sequence. In operation 712, the tile images at the current position of each of the number of two dimensional directions in the planned sequence are captured. Operations 710 and 712 are repeated in operation 714 until all images with a different setup for the current positions have been captured. Then repeat from 710 until all positions have been captured. Operation 716 combines all images according to the specific setup conditions used to create any or all of the high resolution image, the high dynamic range image, the multispectral image, the extended depth of field image or the photometric stereo 3D image.

The functions and processes described herein are represented by a sequence of operations that can be implemented by or in hardware, software, or a combination thereof. In the context of software, the blocks represent computer executable instructions that are stored on computer readable media and that when executed by one or more processors, perform the recited operations and functions. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A camera system, comprising:
a housing for enclosing the camera system;
a lens disposed within the housing;
one or more digital sensors coupled to the lens for capturing a plurality of tile images;
a vertical stage disposed in the housing and configured to move the one or more digital sensors in a vertical direction relative to the housing; and
a horizontal stage disposed in the housing and configured to move the one or more digital sensors in a horizontal direction relative to the housing,
wherein the vertical stage and the horizontal stage are configured to move the one or more digital sensors in overlapping increments in the horizontal direction and the vertical direction in a planned sequence while the housing and the lens remain stationary,
wherein the one or more digital sensors capture a tile image at each of the overlapping increments and the plurality of tile images are combined into a final image.

2. The camera system of claim 1, wherein the plurality of tile images are combined using a motion valuation based, at least in part, on using a region of the overlapping increments.

3. The camera system of claim 1, further comprising a vibration suspension stage configured to control the acceleration of the horizontal stage and the vertical stage and reduce the vibration and speed capture of the image.

4. The camera system of claim 1, further comprising an auxiliary camera, coupled to the housing or to the lens and configured to provide a field of view larger than that of the lens, wherein the auxiliary camera is used to assist in the control of the camera system operation.

5. The camera system of claim 1, wherein the combining of the plurality of tile images is obtained, at least in part, by dividing a focal stack into triplets, computing the local focal stack for each triplet and merging the local focal stack for each triplet into the final image.

6. The camera system of claim 1, wherein the one or more digital sensors include wide angle microlenses operating in both the horizontal direction and the vertical direction.

7. The camera system of claim 1, wherein the one or more digital sensors do not include microlenses and the one or more digital sensors are configured to provide wide angle operation in the horizontal direction and the vertical direction.

8. The camera system of claim 1, further comprising a cooling system to cool the ambient air inside the housing.

9. The camera system of claim 8, wherein the cooling system is a thermoelectric device.

10. The camera system of claim 1, further comprising a light source synchronized with the one or more digital sensors such that a tile image is illuminated from different angles or different spectra at each sensor location to reduce the time to capture the plurality of tile images under different illumination conditions.

11. The camera system of claim 1, further comprising a computer to control the horizontal stage, the vertical stage and the one or more digital sensors.

12. A method of capturing an image, comprising:
positioning a camera in a specific location;
moving a lens or a perpendicular stage to a desired location and then maintaining a stationary location of the lens or the perpendicular stage located within the camera;
moving a digital sensor of the camera in a plurality of two dimensional directions relative to the lens in a planned sequence;
positioning the digital sensor in a first location of the planned sequence in a stopped position;
capturing a first tile image at the first location;
positioning the digital sensor in a second location of the planned sequence in a stopped and stationary position;
capturing a second tile image at the second location;
repeating the positioning of the digital sensor at subsequent locations in the planned sequence and capturing a plurality of tile images at each of the subsequent locations until the planned sequence is complete; and
combining the plurality of tile images to create the image upon the completion of the planned sequence.

13. The method of claim 12, further comprising focusing the camera by one of adjusting a focus for each of the plurality of tile images to provide for increased depth of field of the camera or capturing a plurality of images in a plurality of focuses using a focal stack.

14. The method of claim 12, further comprising adjusting an exposure of each of the plurality of tile images or capturing a plurality of tile images with a plurality of exposures to increase the dynamic range of the camera.

15. The method of claim 12, further comprising controlling the positioning of the digital sensor by using an auxiliary camera with an overlapping field of view with the digital sensor.

16. The method of claim 15, further comprising creating a background model with the auxiliary camera, wherein the background model is used by controlling the digital sensor to provide for capturing the entire background and enabling the creation of the image without occluding foreground objects.

17. A camera system, comprising:
a housing for enclosing the camera system;
a lens disposed within the housing;
one or more digital sensors coupled to the lens for capturing a plurality of tile images;
a vertical stage disposed in the housing and configured to move the one or more digital sensors in a vertical direction;
a horizontal stage disposed in the housing and configured to move the one or more digital sensors in a horizontal direction; and
a perpendicular stage disposed in the housing and configured to move the one or more digital sensors in a perpendicular direction or move the lens in a perpendicular direction,
wherein the vertical stage, the horizontal stage and the perpendicular stage are configured to move the one or more digital sensors in overlapping increments in the horizontal direction, the vertical direction and the perpendicular direction in a planned sequence while the housing and the lens remain stationary,
wherein the one or more digital sensors capture a tile image at each of the overlapping increments and the plurality of tile images are combined into a final image.

18. The camera system of claim 17, further comprising a light source coupled to the camera system and synchronized with the one or more digital sensors such that a tile image is illuminated to reduce the time to capture the plurality of tile images under different illumination conditions, the illuminating comprising:
illuminating the tile image from different angles or different spectra at each sensor location using multispectral illumination, or
illuminating the tile image using polarized illumination.

19. The camera system of claim 17, wherein the vertical stage and the horizontal stage are moved simultaneously with the perpendicular stage to prevent the image from drifting while focusing.

20. The camera system of claim 17, further comprising a computer to control the horizontal stage, the vertical stage, the perpendicular stage and the one or more digital sensors, wherein the perpendicular stage and the computer use a main digital sensor from the one or more digital sensors to autofocus the camera system.
